(19) United States
(12) Patent Application Publication
(10) Pub. No.: US 2003/0071848 A1
(43) Pub. Date: Apr. 17, 2003

(54) SYSTEM AND METHOD FOR PRESENTING TABLES IN SELECTABLE PORTIONS

(76) Inventor: MICHAEL CARROLL, WESTFORD, MA (US)

Correspondence Address: MINTZ LEVIN COHN FERRIS GLOVSKY AND POPEO PC, 12010 SUNSET HILL ROAD, SUITE 900, RESTON, VA, 20190, US

(21) Appl. No.: 09/416,536

(22) Filed: Oct. 12, 1999

Related U.S. Application Data
(60) Provisional application No. 60/112,106, filed on Dec. 15, 1998.

(51) Int. Cl. G09G 5/00

(52) U.S. Cl. 345/776

(57) ABSTRACT

A system, method and electronic storage medium for presenting table information includes a table presentation module that presents one or more portions of a table in a graphical user interface and a user-selectable graphics presentation module that presents one or more user-selectable graphical portions in the graphical user interface. Each of the user-selectable graphical portions represents other portions of the table that may be selected by a user for presentation in the graphical user interface. The user-selectable graphics portions may be a tab and the table portions may be one or more rows of the table. An editing module may be provided that enables a user to edit data in the data display of a user-selectable graphical portion to indicate the portion of the table that may be displayed by selecting that user-selectable graphical portion.

### FIELD OF THE INVENTION

This invention relates to a system and method for presenting tables in electronic documents in selectable portions and facilitating navigation within the tables.

### BACKGROUND OF THE INVENTION

Computer programs may be used to present information in tables. Tables generally comprise a grid of cells arranged in rows and columns. Tables may be used to represent a large amount of data.

As a table becomes larger, it becomes difficult for a user to read and input information into that table through a graphical user interface (GUI). For example, a table may have fifty (50) rows. A GUI may only be able to present ten rows to a user at one time because of viewing area limitations of displays. If the user desires to input information in select rows of the table, such as rows 2, 17, 42, and 49, for example, the user may be required to scroll through several screens of the GUI to input that information or reduce the table size to a size that makes it difficult to view each row. Current tables therefore are difficult to navigate.

Other drawbacks also exist with current systems.

### SUMMARY OF THE INVENTION

Accordingly, it is an object of the present invention to overcome these and other drawbacks of current systems.

Another object of the present invention is to provide a system, method, and electronic storage medium that facilitates navigation within a table.

Another object of the present invention is to provide a system, method, and electronic storage medium that presents a portion of a table and enables a user to select presentation of other portions of the table.

Another object of the present invention is to provide a system, method, and electronic storage medium that permits a user to select the portions of a table that are presented on a display.

According to one embodiment of the present invention, a system, method, and electronic storage medium containing code embodied therein is provided that separates a table into portions, displays one portion of the table in a GUI, and represents other portions of the table with a user-selectable portion in the GUI. The user may then select the portion of the table to be displayed in the GUI by selecting the user-selectable portion associated with that table portion.

According to one specific embodiment, rows of a table may be associated with a tab. The GUI may display one row of the table and also display a tab for other rows in the table. The user may then select the row to display by selecting the tab associated with that row. A user may also input information (e.g., text or images) into the tab which may also be displayed in the GUI. The information in the tab may assist the user in determining which tab to select. The information may also be input using a script or other formula to dynamically insert information into one or more tabs based on one or more criteria (described in further detail below).

According to one embodiment of the present invention, a system, method, and electronic storage medium are provided for presenting table information. The system may comprise a table presentation module that presents one or more portions of a table in a GUI, and a user-selectable graphics presentation module that presents one or more user-selectable graphical portions in the GUI. Each of the user-selectable graphical portions may represent other portions of the table that may be selected by a user for presentation in the GUI. The user-selectable graphics portions may comprise tabs and the table portions may be one or more rows of the table. An editing module may be provided that enables a user to edit data in a data display of a user-selectable graphical portion.

Other advantages of the present invention will be apparent from reviewing the detailed description and drawings of the present invention set forth herein.

### BRIEF DESCRIPTION OF THE DRAWINGS

FIG. 1 is an example of a table according to one embodiment of the present invention.

FIGS. 2(a)-(e) depict tabbed tables according to one embodiment of the present invention.

FIG. 3 depicts an example of a table according to another embodiment of the present invention.

FIGS. 4(a)-(c) depict tabbed tables according to another embodiment of the present invention.

FIG. 5 depicts a system for presenting tabbed table information in a GUI according to one embodiment of the present invention.

FIG. 6 depicts a method for presenting tabbed table information according to one embodiment of the present invention.

FIG. 7 depicts a method of selecting tabbed table information according to one embodiment of the present invention.

### DETAILED DESCRIPTION OF THE PRESENT INVENTION

According to one embodiment of the present invention, a system, method, and electronic storage medium is provided for presenting table information in portions and representing other portions of the table with user-selectable portions. A system according to one embodiment of the present invention may separate a table into several portions. As used herein, a table refers to any manner of arranging information. Information may be arranged in boxes, grids, layers, or other format. The portions may comprise one or more rows, columns, or other collection of cells within a table. The system may present one or more of the portions in a GUI along with one or more user-selectable portions. The user-selectable portions may correspond to other portions of the table. For example, the user-selectable portion may comprise a tab, button, icon, or other representation.

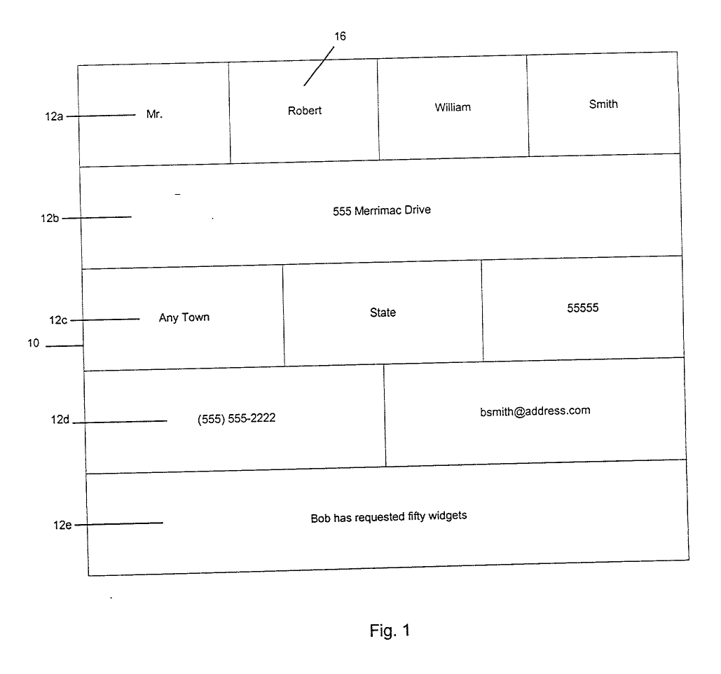

FIG. 1 depicts a table 10 according to one embodiment of the present invention. Table 10 may comprise a plurality of cells 16 arranged into a plurality of rows 12a-12e. The arrangement of cells 16 may vary among rows 12a-12e, as depicted in FIG. 1, for example. For example, row 12a may comprise four cells, whereas row 12e may only comprise one cell. Rows 12a-12e may also comprise a uniform arrangement of cells according to another embodiment.

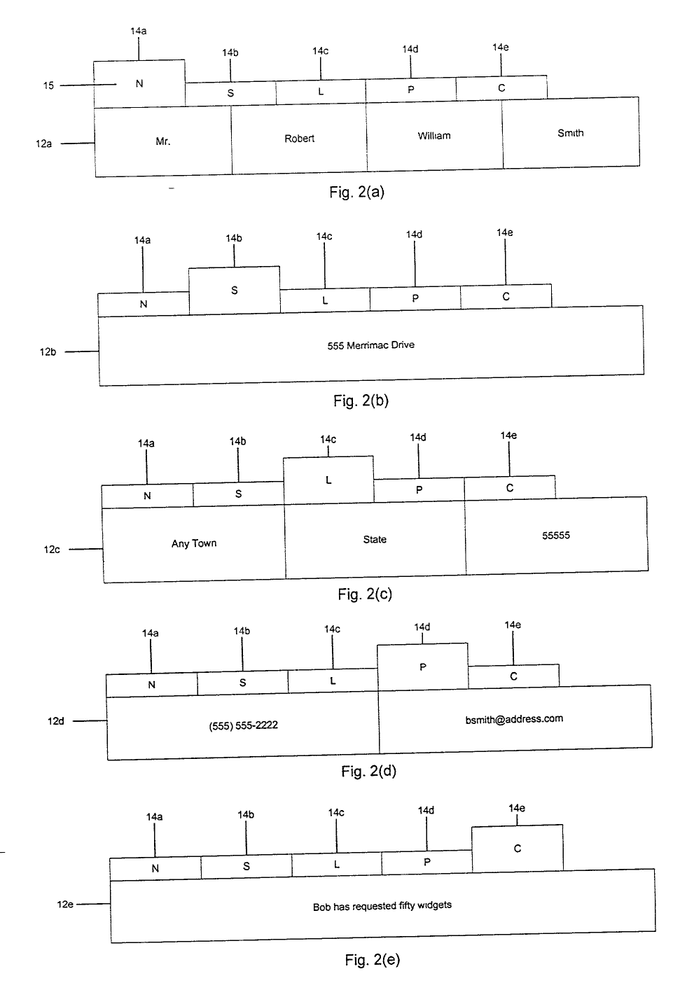

According to one embodiment of the present invention, table 10 may be presented one row at a time, as depicted in FIGS. 2(a)-(e). As depicted in FIGS. 2a-2e, table 10 may comprise rows 12a-12e and one or more user-selectable portions 14a-14e. FIG. 2(a) depicts row 12a, FIG. 2(b) depicts row 12b, FIG. 2(c) depicts row 12c, FIG. 2(d) depicts row 12d, and FIG. 2(e) depicts row 12e. According to one embodiment, user-selectable portions 14a-14e may comprise a tab. User-selectable portions 14a-14e may be associated with one or more rows 12a-12e and may be selected by a user through a GUI. For example, user-selectable portion 14a may be associated with row 12a, user-selectable portion 14b may be associated with row 12b, user-selectable portion 14c may be associated with row 12c, user-selectable portion 14d may be associated with row 14d, and user-selectable portion 14e may be associated with row 12e. Upon selection, the one or more rows 12a-12e associated with user-selectable portions 14a-14e may be displayed.

As depicted in FIGS. 2(a)-(e), user-selectable portions 14a-14e may have a data display portion 15 associated with user-selectable portions 14a-14e for displaying data. According to one embodiment, data in user-selectable portions 14a-14e may comprise textual information, as for example, depicted in FIGS. 2(a)-(e). Data display portion 15 may also comprise colors, shading, grading, lines, highlighting, flashing, or other methods or mechanisms for distinguishing user-selectable portions 14a-14e. Additionally, as depicted in FIGS. 2(a)-(e), one or more of the user-selectable portions 14a-14e may have different sizes.

For example, a user-selectable portion 14 corresponding to the displayed row or rows may be distinguished from other user-selectable portions 14. For example, in FIG. 2(a), user-selectable portion 14a, corresponding to displayed row 12a, may be larger than the other user-selectable portions 14b-14e. Also, user-selectable portion 14a may comprise other distinguishing characteristics from other user-selectable portions 14b-14e.

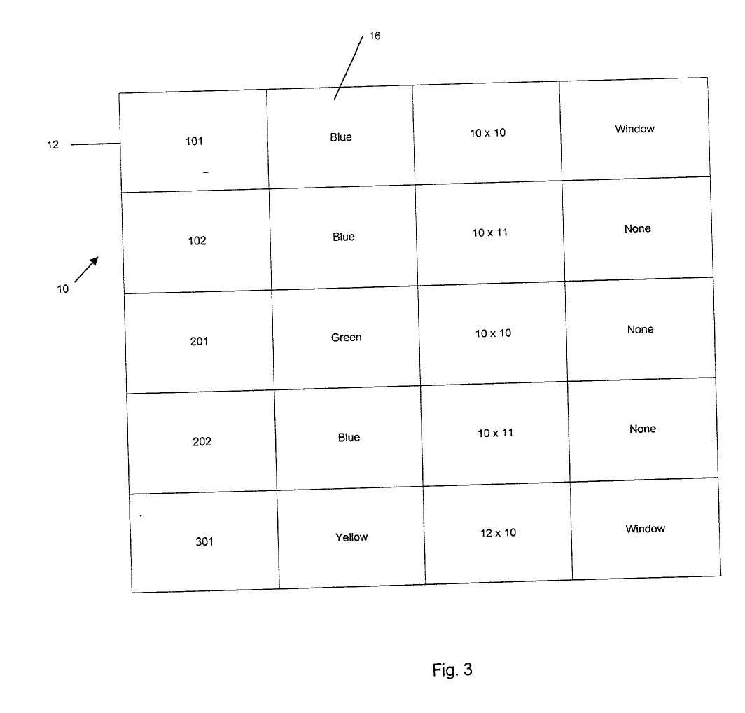

According to another embodiment of the present invention, two or more rows 12a-12e may be grouped together, presented in the GUI, and associated with a single user-selectable portion 14a-14e. For example, FIG. 3 depicts a table corresponding to another embodiment of the present invention. Table 10 comprises a plurality of rows 12a-12e, each comprising four cells 16 arranged in columns. It may be desirable to present groups of information within table 10 together in the GUI. For example, table 10 depicts a painter's chart of work to be performed. The columns may indicate the room, color, room size, and whether the room has any windows. The user may desire to group rooms on the same floor, as for example, the first and second rows and the third and fourth rows in the example of FIG. 3.

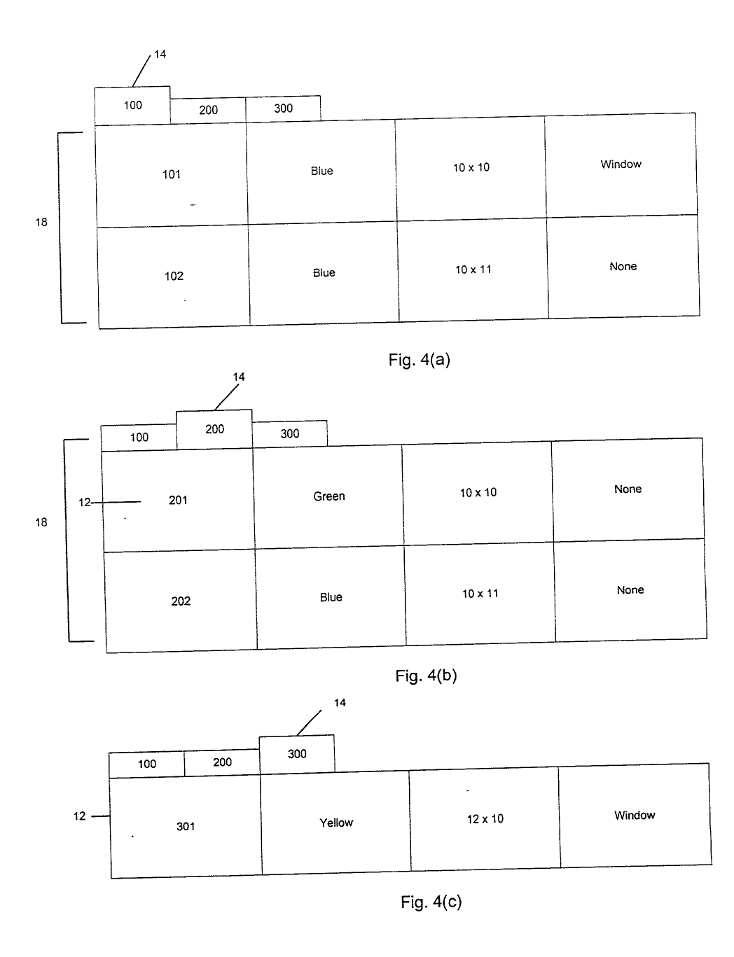

FIGS. 4(a)-(c) depict various groupings 18 of rows 12a-12e of FIG. 3 with user-selectable portions 14a-14e corresponding to either a grouping 18 or a single row 12, as in FIG. 4(c). For example, in FIG. 4(a), the first two rows of table 10 of FIG. 3 are grouped with a user-selectable portion 14. According to this embodiment, user-selectable portion 14 associated with grouping 18 of FIG. 4(a) may comprise the number “100” to represent that the rows are for rooms on the first floor. FIG. 4(b) depicts the third and fourth rows and FIG. 4(c) depicts the fifth row.

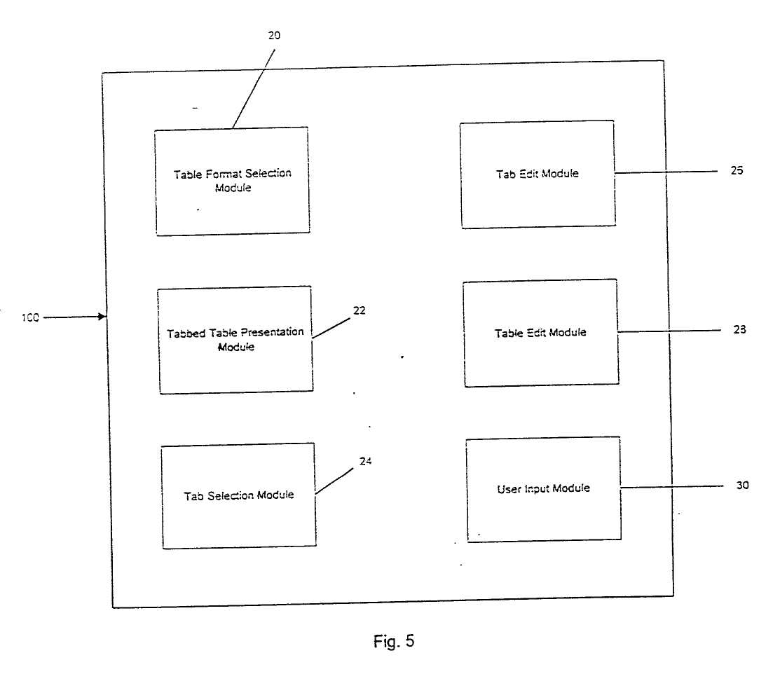

A system 100 according to one embodiment of the present invention is depicted in FIG. 5. System 100 may comprise a program operating on a computer system, such as a personal computer, notebook, portable computer device, mainframe computer, or any other computer system. System 100 may also be distributed between various computers as well such that one module of system 100 may be stored on a database and another module may be stored on a computer connected over a network to the database. The modules of system 100 may be distributed at various points in a computer networked system.

According to one embodiment, system 100 comprises a table format selection module 20, a table presentation module 22, a tab selection module 24, a tab edit module 26, and a table edit module 28. System 100 may comprise additional modules as well.

Table format selection module 20 may comprise a module that enables a user to select the format of a table. For example, table format selection module 20 may comprise a portion of a computer program that presents a menu to a user to select the format of a table. Table format selection module 20 may enable the user to select the number of rows and columns, the size of the rows and columns, the manner in which the rows and columns are depicted, and other formatting options about a table, as are known in the art.

Table format selection module 20 may also enable a user to select the format for presenting the table in a GUT. According to one embodiment, table format selection module 20 may enable a user to select whether to present table 10 with one or more user-selectable portions 14a-14e associated with one or more of the portions of table 10. For example, table format selection module 20 may present a menu in a GUI to the user and permit the user to select to present table 10 in a tabbed row format, as for example, depicted in FIGS. 2 and 4. Table format selection module 20 may then receive a selection from the user and present table 10 in the format selected.

Table format selection module 20 may also present the user with a menu to select cells 16 that are to be included in grouping 18. A user may desire to group several rows, columns or other cells together for presentation in the GUI. Groupings 18 may then be associated with user-selectable portion 14 and presented in the GUI as depicted in FIGS. 2 and 4, for example.

Table presentation module 22 may comprise a module that presents table information in a GUI. Table presentation module 22 may present table 10 with one or more rows 12 or groupings 18 and one or more user-selectable portions 14. For example, user-selectable portions 14 may be tabs, icons, radio buttons or other representations. Table presentation module 22 may also present a grouping of cells associated with a selected user-selectable portion 14.

For example, as depicted in FIG. 2(a), if the selected tab is user-selectable portion 14a, then table presentation module 22 may present row 12a corresponding to user-selectable portion 14a, along with user-selectable portions 14b-14e. As depicted in FIG. 4(a), table presentation module 22 may present grouping 18 corresponding to the selected user-selectable portion 14. According to one embodiment of the present invention, upon initial presentation of table 10, table presentation module 22 may present first row 12 or grouping 18 in table 10. Other rows 12 or groupings 18 may also be presented in the initial presentation before a user has selected user-selectable portion 14. For example, a default row 12 or grouping 18 may be assigned by a user.

Tab selection module 24 may enable a user to select a user-selectable portion 14, such as a tab, through a GUI. Tab selection module 24 may then forward information about the user-selectable portion 14 selected to table presentation module 22, which in turn presents row 12 or grouping 18 corresponding to the selected user-selectable portion 14. Tab selection module 24 may comprise a keyboard, mouse, pen, touch screen, voice response unit, motion detector, or other mechanism that enables a user to select user-selectable portion 14 presented in a GUI. Tab selection module 24 may also comprise software portions that receive signals from hardware devices and translate those signals into selections from a GUI. Such software portions and hardware are well known.

Tab edit module 26 may comprise a module for editing data display portion 15 of user-selectable portions 14. Tab edit module 26 may enable a user to alter the text, color, format, size, shape, dimension, flash, scroll, lines, or any other characteristic of data display portion 15 or user-selectable portions 14. Tab edit module 26 may be activated by selecting a tab and then presenting an edit menu to a user. Presentation of edit menus may be performed according to known methods for alternating presentation of information in a GUI.

Similarly, table edit module 28 may enable a user to edit information within cells 16 of table 10. Table edit module 28 may enable a user to alter the text, color, format, size, shape, dimension, flash, scroll, lines, or any other graphical characteristic of any cell 16 within table 10. Editing of information in cells 16 of table 10 may be performed according to known methods.

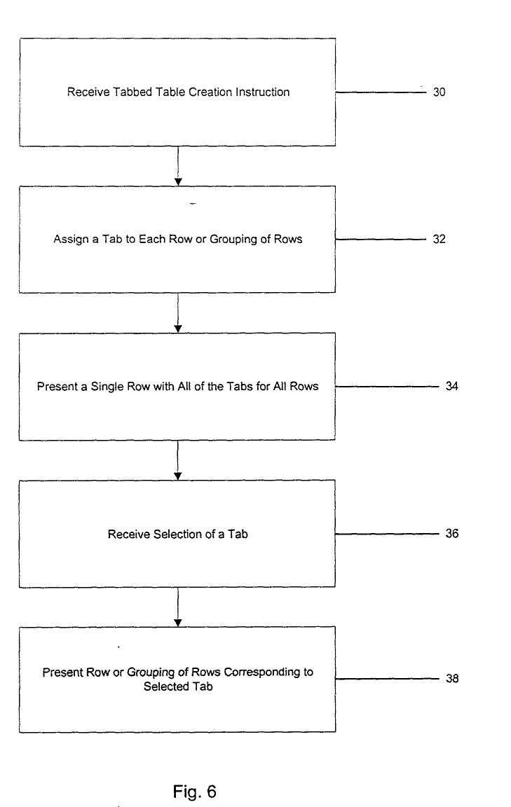

FIG. 6 depicts a method of operation for system 100 according to one embodiment of the present invention. In step 20, system 100 receives an instruction to create table 10 with user-selectable portions 14 in a GUI. This instruction may be provided to system 100 through table format selection module 20. Next, in step 32, system 100 assigns a user-selectable portion 14 to one or more rows 12 or groupings 18 in table 10. According to a specific embodiment, system 100 may assign a user-selectable portion 14 to each row 12 and grouping 18 selected by the user through table format selection module 20. Step 32 may be performed by table format selection module 20 according to one embodiment of the present invention.

In step 34, one or more rows 12 or grouping 18 of table 10 are presented in a GUI along with the user-selectable portions 14 assigned in step 32. According to one embodiment, a single row 12 or group 18 may be presented in step 34, as, for example, depicted in FIGS. 2 and 4 along with each user-selectable portion 14. According to another embodiment, a subset of all user-selectable portions 14 may be presented. According to another embodiment, in step 34, multiple rows 12 or groups 18 may be presented, for example, by enabling a user to select multiple user-selectable portions 14. User-selectable portions 14 may be selected simultaneously by use of a key combination, a select and drag operation, voice response, touch screen, or other method for selecting multiple user-selectable GUI portions. Step 34 may be performed by table presentation module 22.

After table 10 and tabs have been presented in step 34, system 100 may receive a selection of a user-selectable portion 14 presented by table presentation module 22 from a user in step 36. Step 36 may be performed by tab selection module 24.

Upon selection of a user-selectable portion 14, system 100 may present row 12 or grouping 18 corresponding to the user-selectable portion 14 selected in step 38. Further, the appearance of user-selectable portions 14 may be changed to indicate that the user-selectable portion 14 selected corresponds to the displayed row 12 or grouping 18. Presentation of row 12 or grouping 18 in step 38 may be performed by table presentation module 22.

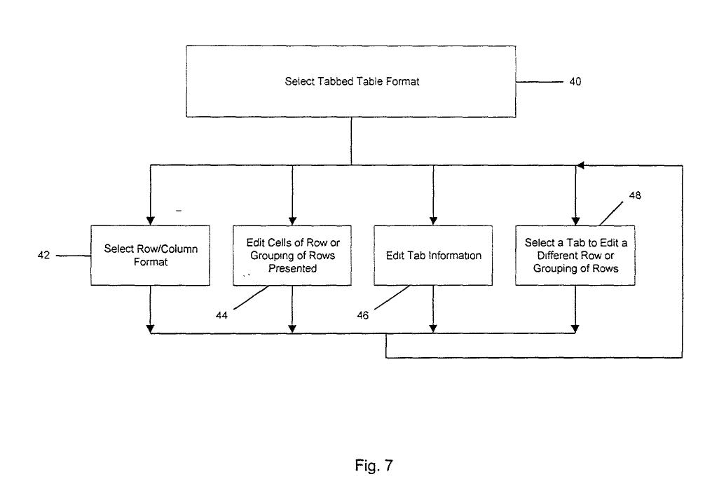

FIG. 7 depicts the operation of system 100 from a user's perspective. Specifically, a user may operate system 100 as follows. In step 40, a user selects a table having user-selectable portions in a GUI. Step 40 may be performed by a user selecting from a menu in a windowing environment, for example. Selection of an item from a menu in step 40 may be performed according to any method for enabling a user to input information.

Upon selection of a table format, the user may perform any of steps 42, 44, 46 or 48. After performance of one of those steps, the user may perform any of steps 42, 44, 46, or 48 again or exit the system. These steps continue until the user exits the system.

In step 42, the user may input information regarding the formatting of the table as described above with respect to table presentation module 22. In step 44, the user may edit the cells of row 12 or grouping 18 presented in a GUI. In step 46, the user may edit the data display portion 15 of user-selectable portion 14. In step 48, the user may select one or more user-selectable portions 14 so that system 100 presents row 12 or grouping 18 associated with that user-selectable portion. These steps may be repeated until the user exits system 100, for example.

Accordingly, the present invention provides a system for enabling a user to create and edit table 10 while being able to more easily navigate within table 10. By inputting information in data display portion 15 of user-selectable portions 14, a user may select rows 12 or grouping of rows 18 desired to view or edit by selecting user-selectable portion 14 corresponding to those rows 12 or groupings 18.

Therefore, in the example set forth in the background above, if a user desires to edit rows 2, 17, 42, and 49, the user may select the tab for row 2, edit row 2, select the tab for row 17, edit row 17, etc. Also, the user may select several or all of the tabs for rows 2, 17, 42, and 49 and edit them as a user would edit other information in table 10. In either case, the user may navigate within table 10 without having to scroll through several pages of information. Further, by grouping cells, the user may be able to view and edit rows of a table which often are edited at the same time.

According to another object of the present invention, changing which row 12 or grouping 18 that is presented in the GUI may be performed automatically. According to this embodiment, table format selection module 20 may provide an option for a user to select that row 12 or grouping 18 presented in the GUI automatically changes based on the occurrence of one or more events. For example, row 12 or grouping 18 presented next may be selected based upon a predetermined routine, may be the next row in the table, or may be randomly selected. A predetermined routine may be that the order of presentation of rows 12 is based on the alphabetical order of a particular cell within a row. Other methods of selecting the order of presentation of rows 12 or groupings 18 may also be used.

According to one embodiment, the event that triggers the presentation of another row 12 or grouping 18 may comprise the passage of a predetermined amount of time. According to this embodiment, table format selection module 20 may provide a menu for enabling a user to select the time interval between presentation of rows 12 or groupings 18 within table 10. Additionally, a default value may be provided, such as 2000 milliseconds, for example. Other time periods may also be provided. Further, according to an embodiment of the present invention, the system may present a menu to the user to enable the user to select the time interval.

According to another embodiment of the present invention, the predetermined event that causes the system to change row 12 or grouping 18 presented may comprise user initiated action. According to this embodiment, system 100 may also comprise a user input module 30. User input module 30 may comprise a device for enabling the user to input information into a computer system. User input module 30 may comprise a keyboard, pen, touch-screen, mouse, track ball, joystick, voice response unit, or any other mechanism that enables a user to input information. According to this embodiment, upon receiving a predetermined user input, system 100 may then activate tabbed table presentation module 22 to present a different row 12 or grouping 18 in the GUI. For example, the predetermined event may comprise a computer mouse “click.” Upon each mouse “click,” a different row 12 or grouping 18 may be presented in the GUI. The order of presentation of rows 12 or groupings 18 may vary as discussed above.

Further, as discussed above, according to this embodiment, a menu may be presented to the user to select the user action that causes transitioning from presenting one row 12 or grouping 18 to another row 12 or grouping 18. For example, the user may be presented with the option of having row 12 or grouping 18 presented changed based upon a mouse “click.” Other user initiated events may also be presented in the menu. Further, the user may be able to input script or other macro-type actions that initiate presentation of a different row 12 or grouping 18.

According to yet another embodiment of the present invention, the predetermined event may be determined according to a formula or algorithm defined by the user. The user may create formulas based on fields and functions within a script and the row presented may be determined based on the resolution of the formula. Further, the user may desire to periodically have that formula resolved again, so that based on user input, the row presented may be dynamically changed. For example, the user may desire to program the system to present a particular row based on the day of the week. The system may be programmed to modify the displayed row according to any user-defined routine or algorithm. Other formulas or algorithms may also be provided for determining which row 12 or grouping 18 of table 10 to present. The system may also be programmed to display a row based on user input, such as entry of a particular character into a row, or selecting a particular key or external device input. Many other formula based presentations of rows 12 or grouping 18 may be made according to the present invention. According to one embodiment, the formula may resolve to a field called $table-name. The value of the $table-name field may determine the row 12 or grouping 18 of table 10 to present.

According to another embodiment of the present invention, a electronic storage medium having code embodied therein for presenting table information in portions may be provided. For example, the electronic storage medium may comprise a CD-ROM, a floppy disk, a hard disk, or any other electronic storage medium. One or more of the modules of system 100 may comprise code that is provided on the electronic storage medium such that when the electronic storage medium is installed on a computer system, those modules cause the computer system to perform the functions described.

According to one embodiment, table format selection module 20, tabbed table presentation module 22, tab selection module 24, tab edit module 26, table edit module 28 and user input module 30 may comprise code that, when installed on a computer, perform the functions described above. Also, only some of the above-listed modules may be provided in code.

According to one specific embodiment of the present invention, system 100 may comprise components of a software system licensed by the Lotus Development Corporation under the names Lotus Notes™ and Lotus Domino Designer™. System 100 may operate on a network and may be connected to other systems 100 sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A system for presenting information in a table in a graphical user interface, the table comprising a plurality of rows, the system comprising:
a table presentation module that presents one or more portions of a table in a graphical user interface; and
a user-selectable graphics presentation module that presents one or more user-selectable graphical portions in the graphical user interface, each user selectable graphical portion representing other portions of the table.

2. The system of claim 1, further comprising:
a user selection module for receiving selection of one or more of the user-selectable graphics portions; and
wherein the table presentation module is responsive to the user-selection module to present one or more table portions assigned to the one or more selected user-selectable graphics portions.

3. The system of claim 1, wherein the user-selectable graphics portion comprises a tab.

4. The system of claim 1, wherein the table portions comprise one or more rows of the table.

5. The system of claim 1, wherein the user-selectable portions comprise a data display; and
further comprising an editing module that enables a user to edit data in the data display of one or more of the user-selectable graphical portions.

6. A system for presenting table information, the table comprising a plurality of rows, the system comprising:
table presentation means for presenting one or more portions of a table in a graphical user interface; and
user-selectable graphics presentation means for presenting one or more user-selectable graphical portions in the graphical user interface, each user selectable graphical portion representing other portions of the table.

7. The system of claim 6, further comprising:
a user selection means for enabling a user to select one or more of the user-selectable graphics portion; and
wherein the table presentation means is responsive to the user-selection module to present one or more table portions assigned to the one or more selected user-selectable graphics portions.

8. The system of claim 6, wherein the user-selectable graphics portion comprises a tab.

9. The system of claim 6, wherein the table portions comprise one or more rows of the table.

10. The system of claim 6, wherein the user-selectable portions comprise a data display; and
further comprising an editing means for enabling a user to edit data in the data display of one or more of the user-selectable graphical portions.

11. A method for presenting table information comprising:
partitioning a table into one or more portions;
presenting one or more of the portions in a graphical user interface;
assigning other portions of the table to one or more user-selectable graphics portions; and
presenting one or more of the user-selectable graphics portions in the graphical user interface.

12. The method of claim 11, further comprising the step of:
receiving selection of one or more of the user-selectable graphics portions; and
presenting the table portions assigned to the one or more selected user-selectable graphics portions.

13. The method of claim 11, wherein the step of partitioning the table comprises partitioning the table into groups of one or more rows and wherein the step of presenting comprises presenting one or more rows.

14. The method of claim 13, wherein the step of presenting comprises presenting a single row.

15. The method of claim 11, further comprising the step of presenting data in one or more of the user-selectable graphics portions to identify the table portions to which that user-selectable graphics portions is assigned.

16. An electronic storage medium having code embodied therein for causing a processor to present table information in portions comprising:
partitioning code that causes a processor to partition a table into one or more portions;
presenting code that causes a processor to present one or more of the portions in a graphical user interface;
assigning code that causes a processor to assign other portions of the table to one or more user-selectable graphics portions; and
graphics portions presenting code that causes a processor to present one or more of the user-selectable graphics portions in the graphical user interface.

17. The medium of claim 16, further comprising:
selection receiving code that causes a processor to receive selection of one or more of the user-selectable graphics portions; and
table portions presenting code that causes a processor to present the table portions assigned to the one or more selected user-selectable graphics portions.

18. The medium of claim 16, further comprising:
row partitioning code that causes a processor to partition the table into groups of one or more rows; and
row presenting code that causes a processor to present one or more rows.

19. The medium of claim 18, wherein the row presenting code comprises presenting a single row.

20. The medium of claim 16, further comprising data presenting code that causes a processor to present data in one or more of the user-selectable graphics portions to identify the table portions to which that user-selectable graphics portions is assigned.
